(19) United States
(12) Patent Application Publication
(10) Pub. No.: US 2016/0216450 A1
(43) Pub. Date: Jul. 28, 2016

(54) Systems And Methods For Coupling Electromagnetic Radiation From Fiber Arrays Into Waveguides And Photonic Chips

(71) Applicant: The Trustees Of Columbia University In The City Of New York, New York, NY (US)

(72) Inventors: Dirk R. Englund, New York, NY (US); Jacob Mower, New York, NY (US)

(73) Assignee: The Trustees Of Columbia UniverSity In The City Of New York, New York, NY (US)

(21) Appl. No.: 14/252,110

(22) Filed: Apr. 14, 2014

Related U.S. Application Data
(63) Continuation of application No. PCT/US12/60565, filed on Oct. 17, 2012.
(60) Provisional application No. 61/548,061, filed on Oct. 17, 2011.

(51) Int. Cl. G02B 6/30; G02B 6/26; G02B 6/42

(52) U.S. Cl. CPC G02B 6/30; G02B 6/4291; G02B 6/262

(57) ABSTRACT

Systems and methods for coupling electromagnetic radiation from fiber arrays into waveguides and photonic chips are disclosed. In one aspect of the disclosed subject matter, systems for coupling electromagnetic radiation from an optical fiber into a waveguide are provided. In some embodiments, the system can include at least one optical fiber having a distal portion adapted for allowing a portion of an electromagnetic field to exist outside of the fiber. At least one waveguide can have a surface adapted to receive the distal portion of the fiber and be shaped such that the fiber presses against the waveguide creating a repeatable interface. The fiber and the waveguide are arranged so at least part of the portion of the field existing outside the fiber extends into the waveguide. In another aspect of the disclosed subject matter, methods for coupling electromagnetic radiation from the fiber to a photonic integrated chip are disclosed.

### CROSS-REFERENCE TO RELATED APPLICATIONS

This is a continuation application based on PCT/US12/60565, filed on Oct. 17, 2012, which claims priority from U.S. Provisional Application Ser. No. 61/548,061, filed Oct. 17, 2011, the entirety of the disclosure of which is explicitly incorporated by reference herein.

### STATEMENT REGARDING FEDERALLY SPONSORED RESEARCH OR DEVELOPMENT

This invention was made with government support under Award No. W911NF-10-1-0416 awarded by DARPA. The government has certain rights in the invention.

### BACKGROUND

The disclosed subject matter relates to systems and methods for coupling electromagnetic radiation from fiber arrays into waveguides and photonic chips.

Photonic integrated chips (PICs) can provide compact, efficient architectures for classical and quantum information processing systems. There are several ways to couple light (or other electromagnetic radiation) from one or many optical fibers into a PIC.

A grating coupler is a coupling configuration where the end, or butt, of an optical fiber can be connected to a diffraction grating, and the grating is etched into a waveguide on a PIC. Grating couplers can allow vertical coupling between a PIC and one or many optical fibers, and can couple to the edge of the chip in a planar configuration.

End-to-end coupling, also known as butt-coupling, is a coupling configuration where one optical channel can be brought into contact with a second so that light flowing through the first to the second passes through a hard interface where the first channel ends and the second begins. End-to-end coupling can provide for planar coupling configuration, but can also be expensive, time consuming, intolerant of alignment errors, and necessitate that the cross-sectional areas of the optical channels be of similar size.

Other techniques for coupling an optical fiber to a PIC include multi-stage inverse taper couplers or transformation optics. Such techniques can rely on a fiber that is butt-coupled to a large tapered polymer waveguide. There is a need for an improved coupling configuration.

### SUMMARY

Systems and methods for coupling electromagnetic radiation from fiber arrays into waveguides and photonic chips are disclosed herein.

In one aspect of the disclosed subject matter, systems for coupling electromagnetic radiation from an optical fiber into a waveguide are provided. An exemplary system can include at least one optical fiber for transmitting the electromagnetic radiation, the fiber having a main portion and a distal portion, with the distal portion adapted for allowing at least a portion of a field generated by the electromagnetic radiation to exist outside of the at least one optical fiber. At least one waveguide can have a surface adapted to receive the distal portion of the optical fiber, the waveguide shaped such that the optical fiber presses against the waveguide creating a repeatable interface. The fiber and the waveguide can be arranged such that at least part of the portion of the field existing outside of the at least one optical fiber extends into the waveguide.

In some embodiments, the system can also include a photonic integrated chip. The waveguide can be attached to the surface of the photonic integrated chip. In some such embodiments, the optical fiber can be substantially parallel to the surface of the photonic integrated chip. In other embodiments, the surface of the waveguide can be substantially orthogonal to the surface of the photonic integrated chip.

In some embodiments, the main portion of the optical fiber has a diameter large enough so that no part of the field exists outside of the main portion of the at least one optical fiber.

In some embodiments, the distal portion of the optical fiber further can include a tapered region and a narrow region, the tapered region disposed between the narrow region and the main portion. In some such embodiments, the tapered region can be between 10-1000 μm long, and the narrow region can have a diameter between 0.1-10 μm.

In some embodiments, the waveguide can be curved. In other embodiments, the waveguide can further include a straight portion, where the at least one optical fiber and the at least one waveguide can be arranged so that the repeatable interface is created along the straight portion of the waveguide.

The waveguide can be a large polymer waveguide, a high-index waveguide, an organic waveguide, or an inorganic waveguide.

In some embodiments, the surface of the waveguide can be concave. In other embodiments, it can further include an overhang projecting from the surface of the waveguide.

In some embodiments, thin spacers can be arranged along the surface of the photonic integrated chip adjacent to the surface of the at least one waveguide. The optical fiber can then rest on the thin spacers rather than contacting the surface of the photonic integrated chip. In some such embodiments, the thin spacers can be integral with the photonic integrated chip. In other embodiments, the thin spacers can be integral with the waveguide.

In some embodiments, the repeatable interface includes an interaction length corresponding to a desired coupling of the field from the at least one optical fiber into the at least one waveguide.

In another aspect of the disclosed subject matter, methods for coupling electromagnetic radiation from at least one optical fiber to a photonic integrated chip are disclosed. An exemplary method can include positioning at least one optical fiber above the surface of the photonic integrated chip to approximately align optical fiber with the waveguide. Translating the optical fiber downwards can bring the at least one optical fiber into contact with the surface of the photonic integrated chip. Translating the optical fiber in a direction of the waveguide along the surface of the photonic integrated chip can bring the at least one optical fiber into contact with the surface of the waveguide.

In some embodiments, the method can include translating the optical fiber upwards relative to the surface of the photonic integrated chip, so that the optical fiber does not contact the surface of the photonic integrated chip. Translating the optical fiber upwards can further include pressing the fiber against an overhang or a portion of a concave surface of the waveguide.

In another aspect of the disclosed subject matter, methods for coupling electromagnetic radiation from a plurality of optical fibers to a photonic integrated chip are disclosed. An example method includes positioning the optical fibers above the surface of the photonic integrated chip so that each of the optical fibers is approximately aligned with a corresponding waveguide. Translating the plurality of optical fibers downwards can bring the fibers into contact with the surface of the photonic integrated chip. Translating the optical fibers in a direction of the corresponding waveguides along the surface of the photonic integrated chip can bring the plurality of fibers into contact with the surfaces of the corresponding waveguides.

In some embodiments, the plurality of optical fibers can be equidistantly spaced. In some such embodiments, the plurality of waveguides can be equidistantly spaced to correspond to the plurality of optical fibers.

### BRIEF DESCRIPTION OF THE DRAWINGS

FIGS. 1A-1C show an exemplary system for coupling electromagnetic radiation from an optical fiber into a waveguide according to some embodiments of the disclosed subject matter.

FIG. 2 shows an exemplary process for aligning a plurality of tapered fibers with a plurality of waveguides according to some embodiments of the disclosed subject matter.

FIG. 3 shows an alternative shape of the waveguide according to some embodiments of the disclosed subject matter.

FIG. 4 shows an alternative embodiment for the system that utilizes spacers along the surface of the PIC according to some embodiments of the disclosed subject matter.

FIG. 5 shows an exemplary process for aligning a plurality of tapered fibers with a plurality of waveguides according to some embodiments of the disclosed subject matter.

FIGS. 6A-6B show exemplary symmetric and anti-symmetric mode profiles used to calculate the beat length for a silica fiber and polymer waveguide according to some embodiments of the disclosed subject matter.

FIG. 7 shows an exemplary plot of effective mode index against wavelength for the interface between a silica fiber and polymer waveguide according to some embodiments of the disclosed subject matter.

FIGS. 8A-8B shows an exemplary plot of the effective mode profile of the small end of an inverse-tapered silicon waveguide surrounded by a polymer waveguide according to some embodiments of the disclosed subject matter.

FIGS. 9A-9B shows an exemplary plot of the effective mode profile of the wide end of an inverse-tapered silicon waveguide surrounded by a polymer waveguide according to some embodiments of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the Figs., it is done so in connection with the illustrative embodiments.

### DETAILED DESCRIPTION

The disclosed subject matter provides techniques to align one or more optical fibers to waveguides on a chip in a robust, easy-to-implement fashion.

For purpose of illustration and not limitation, exemplary embodiments of the disclosed subject matter will be described with reference to the figures. The exemplary systems demonstrate a robust, easy to implement mechanism for coupling light (or other electromagnetic radiation) from an array of optical fibers into waveguides attached to a PIC using evanescent coupling. Through the shape of the waveguides and tension between the fibers and the waveguides, the same coupling configuration can be maintained even if the fibers were translated by several tens of microns. The exemplary methods demonstrate how to put the fibers into alignment with the waveguides.

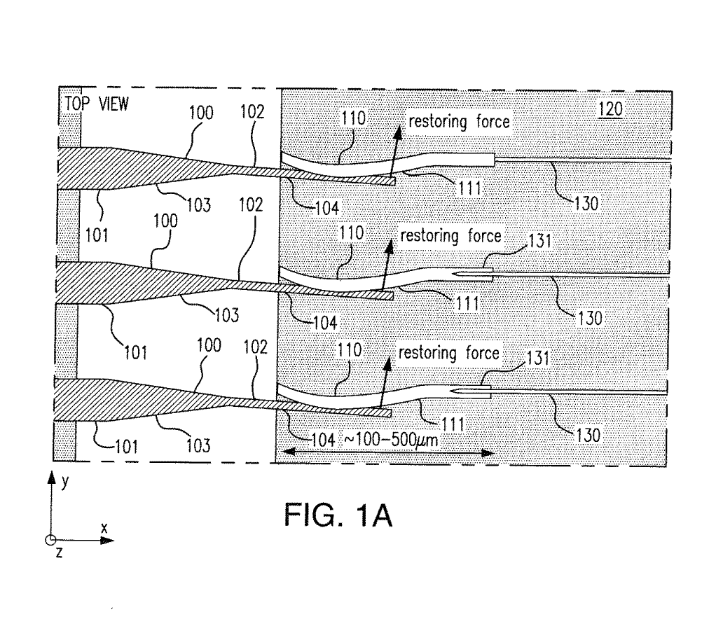

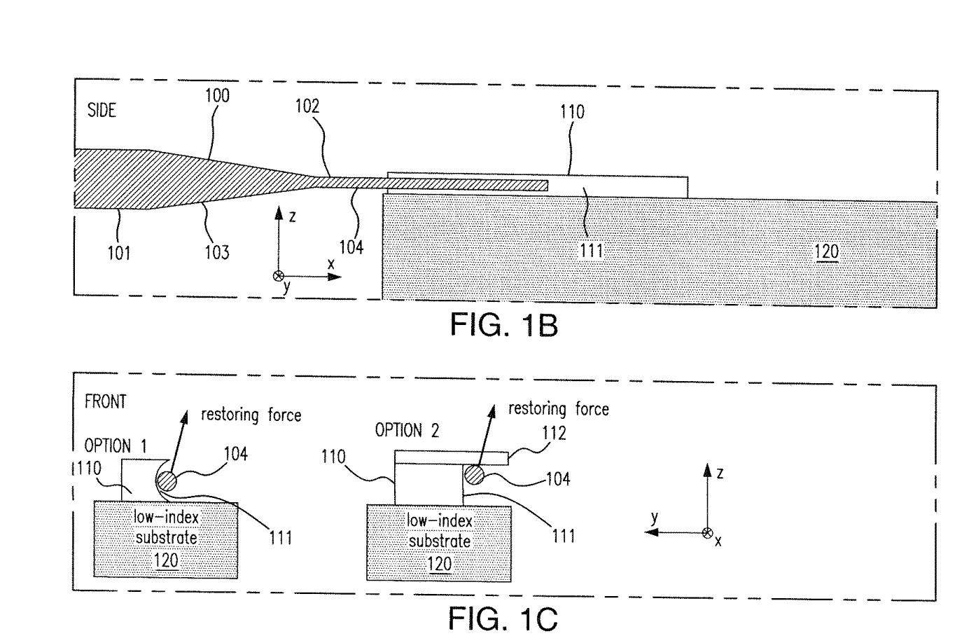

Referring to FIG. 1, an exemplary system for coupling electromagnetic radiation from an optical fiber into a waveguide is disclosed. An array of optical fibers 100 can be attached in a planar configuration, which can be accomplished with, e.g., conventional chip holders used in connection with electrical chip carriers. The fiber 100 can be constructed from standard silicon dioxide, or can include impurities to raise the index of refraction. The array can be of size 1×N, for N potentially >100. The main portion 101 of the fibers 100 can be large enough so that no evanescent field reaches the edge of the fiber. For example, the main portion 101 of the optical fiber 100 can be the standard diameter of 125 microns, which results in only 0.2 dB/km loss. The fibers 100 can be attached at a location along the main portion 101; thus, the connection can substantially prevent photon loss. Proximal to this connection, the fiber 100 can have a distal portion, 102. The distal portion 102 can be adapted to allow at least a portion of a field generated by electromagnetic radiation to exist outside of the fiber 100. This portion of the field outside of the fiber 100 can be referred to as an evanescent tail or evanescent field. The evanescent field becomes strong when the diameter of the fiber 100 shrinks to the order of the wavelength. When a fiber 100 and a waveguide 110 are placed near each other, their evanescent fields can overlap, causing a transfer of power between the resonant modes. This phenomenon is known as evanescent coupling. When the overlap is equal to the beat length (see below, paragraph [0033]), then the total power will transfer between the fiber 100 and the waveguide 110.

For example, the distal portion 102 can have a tapered region 103. The tapered region 103 can be 10-1000 μm long. The distal portion 102 can also have a narrow region 104. The narrow region 104 can have a diameter between 0.1-10 μm so that the optical mode is associated with an evanescent tail.

A waveguide 110, which can be mounted on the PIC 120, can be adapted to receive the distal portion 102 of the fiber 100. For example, the surface 111 of the waveguide 110 can be adapted to receive the narrow region 104 of the fiber 100. Illustrative configurations for the surface 111 of the waveguide 110 include, but are not limited to, being concave (as illustrated in FIG. 1(c)) or having an overhang 112 projecting from the surface 111 of the waveguide 110 (as illustrated in FIG. 1(c)). The overhang 112 can be orthogonal to the surface 111 of the waveguide 110, but it does not have to be. The overhang 112 can function as long as the fiber 100 can be in contact with the waveguide 110 and the overhang 112 sufficiently prevents the fiber 100 from translating vertically due to misalignment. The evanescent tail from the narrow region 104 can overlap with the waveguide 110, which can result in coupling between the two.

For efficient transfer of light between the optical fiber 100 and the waveguide 110, the interaction length can be controlled by manipulating the shape and dimensions of the waveguide and the fiber. To this end, the waveguide 110 can be bent in a specific shape so that a repeatable interface is created between the waveguide 110 and the straight fiber 100. For example, the waveguide 110 can be curved. The transmission through the curve of the waveguide 110 can depend on the radius of curvature. The curvature can be small enough so that electromagnetic radiation can be confined by total internal reflection. Practically, this can correspond to a radius of curvature of hundreds of microns. By way of example and not limitation, the radius of curvature can be 100-200 microns.

In accordance with an exemplary and non-limiting embodiment, suitable shape and dimensions of the fiber 100 and the waveguide 110 can be determined using ComSol Multiphysics, which is a commercially available software product, to simulate different geometries using the Finite Element Method. To calculate the beat length, one can find the symmetric and anti-symmetric modes of the fiber 100/waveguide 110 system. Anti-symmetric modes can be characterized in that waves are π out of phase, where as symmetric modes can be characterized in that waves are completely in phase. Anti-crossing, i.e., the point of maximum transmission between the fiber 100 and waveguide 110, can occur only at the wavelength where the difference in the index of refraction for the symmetric and anti-symmetric modes is at a minimum. The beat length can be calculated according to known techniques. By way of example and not limitation, the narrow region 104 of the fiber 100 can have a radius of 1.67 μm; the waveguide 110 can be 1.507 μm wide and 2.07 μm high, and the beat length can be 71.669 μm.

As embodied herein, the optical fiber 100 can press against the waveguide 110, thus maintaining the same configuration even if it were translated by several microns in the x or y directions. In the z-direction, the alignment can also be maintained as the fiber 100 is pressed against the surface 111 of the waveguide 110. The surface 111 of the waveguide 110 can be, but does not have to be, substantially orthogonal to the surface of the PIC 120. By using tension between the fiber 100 and the waveguide 110, a controlled interface is created that is tolerant to misalignment and translation in the x, y, and z directions.

The waveguide 110 can be fabricated in a large polymer waveguide, or in a high-index waveguide, such as group-IV semiconductors or III-V compounds (e.g., silicon, silicon nitride, or gallium arsenide). The waveguide 110 can be organic or inorganic. By way of example and not limitation, an organic waveguide material can be SU-8, used because it is an advanced optical resist for nanofabrication. By way of example and not limitation, an inorganic waveguide material can be silicon nitride (SiN), used for applications requiring CMOS integration. By way of example and not limitation, the waveguide 110 can be formed from SU-8-3000, a polymer with a refractive index of 1.55 at a wavelength of 1550 nm. Additionally, an organic or large polymer waveguide 110 can be attached to a smaller inorganic or high-index waveguide 130. By way of example and not limitation, the smaller waveguide 130 can be silicon. The material and dimensions of the waveguide 110 and tapered fiber 100 can determine the required interaction length for a desired coupling efficiency. In certain embodiments, the contact length can be between 10-100 μm. The contact length can depend on the extent of the evanescent field outside the fiber 100, which in turn can be wavelength dependent. However for increased coupling efficiency, one can approximate the phase matching condition, whereby the effective index of the waveguide 110 mode can be equal to the effective index of the fiber 100 mode. The bent shape of the waveguide 110 can be fabricated using top-down approaches such as optical, electron beam, or imprint lithography. The vertical feature defining the overhang 112 can be created with one mask by using two layers of inorganic or organic materials with different exposure rates or etch rates. By way of example and not limitation, bi-layer poly(methyl methacrylate) (PMMA) resists can be used for metal lift-off steps in nanofabrication, however the overhang 112 can in certain instances be insufficient for this application. Alternatively, multiple masks can be used. By way of example and not limitation, a multistep etch incorporating an optical resist and electrical resist with different widths can be applied.

The smaller waveguide 130 can have an inversely tapered end 131. In certain embodiments, the inversely tapered end 131 can be an adiabatic taper from 50 nm wide to 500 nm with a constant height of 220 nm. At the wide end of the tapered region 131, the waveguide 110 can terminate and the smaller waveguide 130 can continue with the same dimensions as the wide end of the taper 131. The interfaces between the waveguide 110 and the tapered region 131 can be at the narrow end and the wide end of the taper, as abrupt changes in geometry can cause loss. A 0.98 coupling efficiency can be achieved at both interfaces using the materials and dimensions discussed herein. This coupling arrangement between the larger waveguide 110 and the smaller waveguide 130 is known as an inverse taper coupling arrangement.

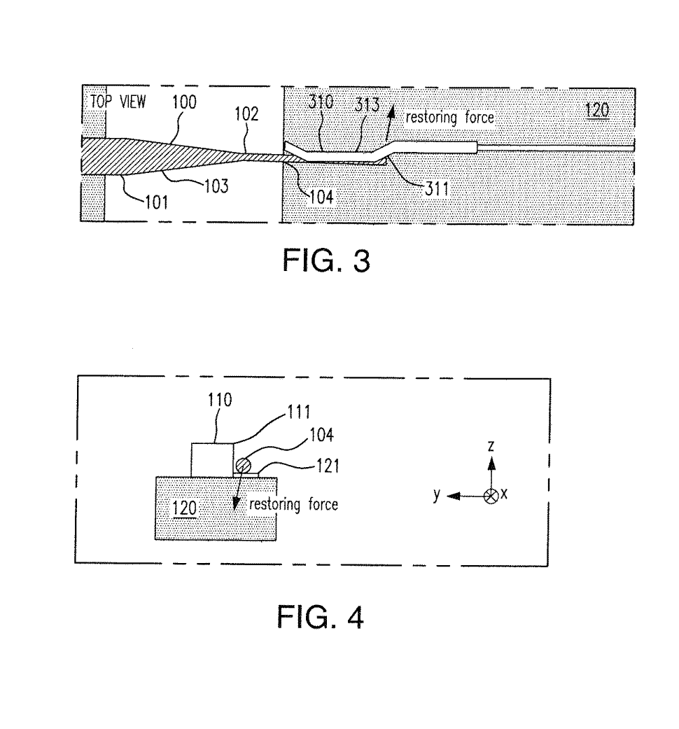

Referring to FIG. 3, an alternative shape of the waveguide 310 according to some embodiments of the disclosed subject matter is shown. The waveguide 310 can be bent such that it includes a straight portion 313. The distal portion 102 of the optical fiber 100 is arranged so that the repeatable interface is created along the straight portion 313. The straight portion 313 can have a length equal to the desired interaction length.

Referring to FIG. 4, one embodiment for the system that utilizes a plurality of thin spacers 121 along the surface of the PIC 120 according to some embodiments of the disclosed subject matter is shown. The thin spacers 121 can be arranged along the surface of the PIC 120 adjacent to the surface 111 of the waveguide 110. The optical fiber 100 can be arranged so that the optical fiber 100 rests on the thin spacers 121 and does not contact the surface of the PIC 120. The spacers 121 can be, for example, about 1 μm high (z-direction) and 1 μm thick (x-direction), but one of ordinary skill in the art will appreciate that other dimensions can be employed. The spacers 121 can be integral with the surface of the PIC 120. Additionally or alternatively, the spacers 121 can also be integral with the waveguide 110.

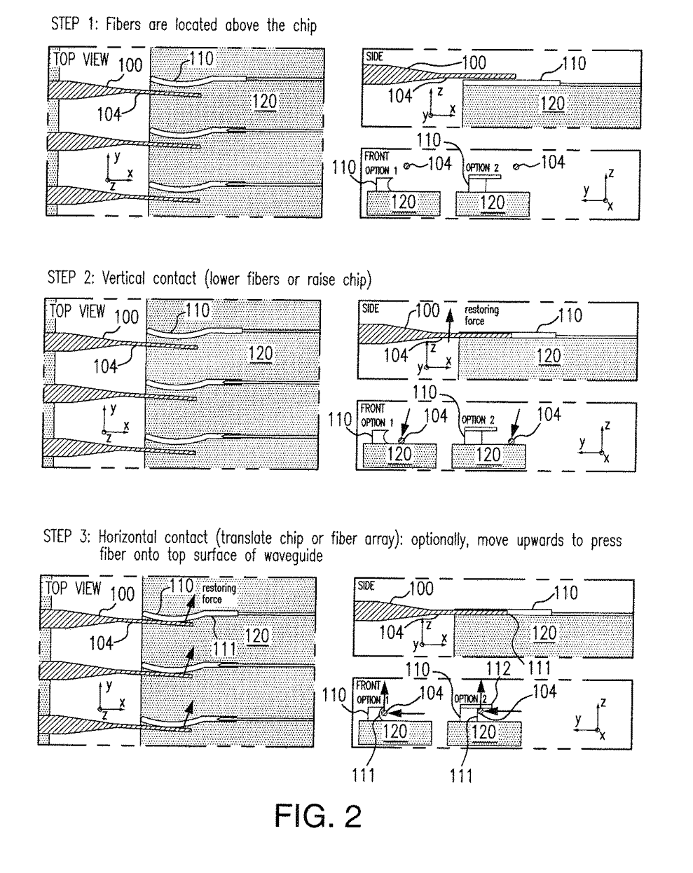

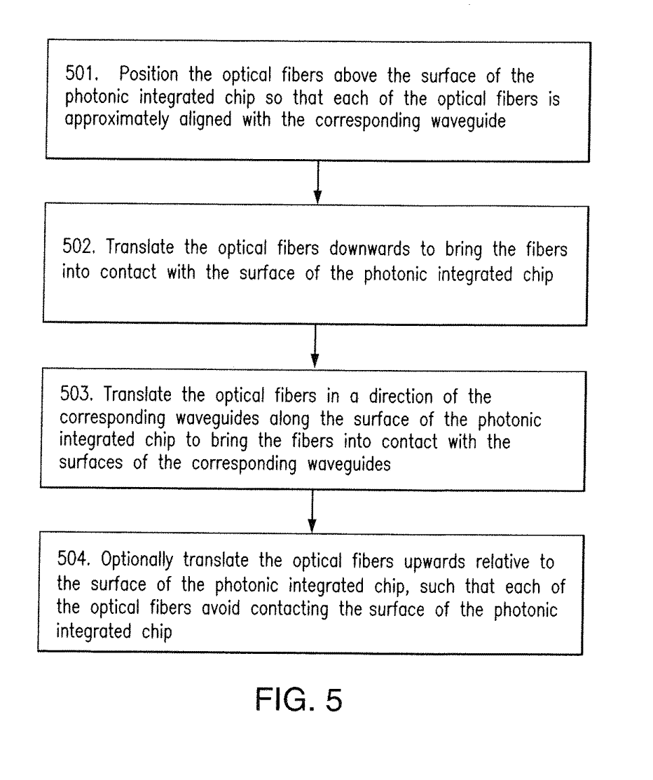

Referring to FIG. 2 and FIG. 5, an exemplary process for aligning the waveguides 110 and fibers 100 is provided. The PIC 120 and fibers 100 can be roughly positioned (501) on top of each other so that they are aligned in the x direction and each fiber is on the appropriate side of the corresponding waveguide (i.e. the side of the waveguide with the surface adapted to receive the fiber). In this way, the fibers 100 can be approximately aligned with the waveguide 110. FIG. 2 shows the waveguides 110 and fibers 100 separated in the y and z directions. In certain embodiments, the fibers 100 can be equidistantly spaced, and the waveguides 110 can be equidistantly spaced to correspond to the fibers 100.

The PIC 120 and fibers 100 can be brought into alignment in the z direction by translating the PIC 120 up or, as can be more convenient, translating the fibers 100 down (502). For example, this can be accomplished by closing a latch mechanism on the fiber holder. The translation can intentionally overshoot the in-plane configuration so that all fibers 100 are brought into contact with the PIC 120 despite potentially different initial heights.

Horizontal contact can be established between the fibers 100 and waveguides 110 by translating in the y direction (503). Again, overshooting this motion can result in a restoring force in the fibers 100. For example, the fiber can be flexible such that when a force is applied, the fibers can bend rather than break.

In certain embodiments, the fibers 100 can be translated upwards (504) to press against the underside of the surface 111 of the waveguide 110. This can be used, e.g., when the waveguide 110 has low refractive index. Thus the fibers 100 can contact only the waveguides 110, not the low-index substrate of the PIC 120. Again, the surface 111 of the waveguide 110 can have many different configurations, including being concave or having an overhang 112.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Such modifications are intended to fall within the scope of the appended claims.

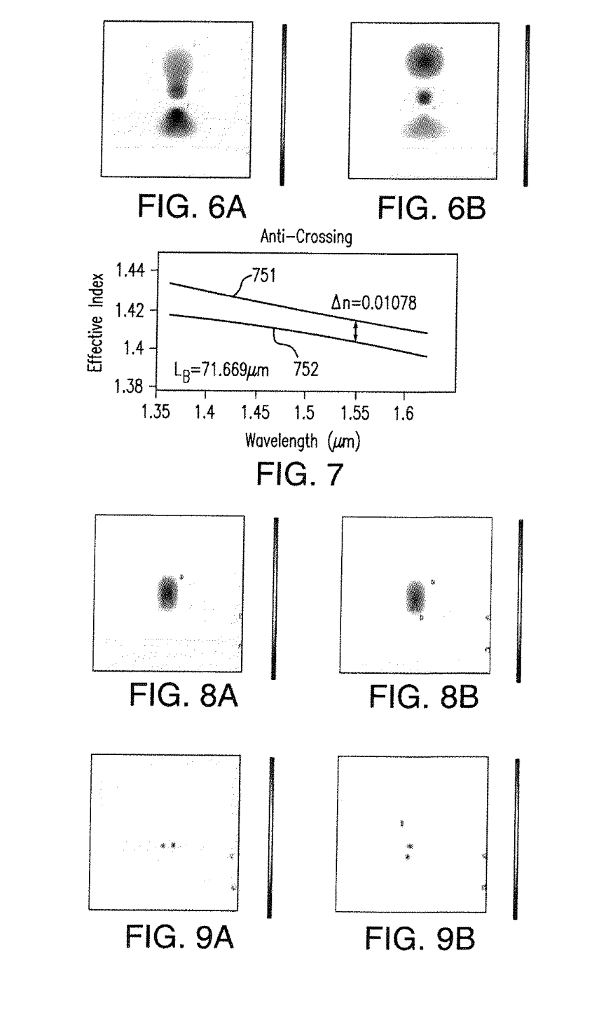

Referring to FIG. 6, the symmetric and anti-symmetric mode profiles used to calculate the beat length are shown in FIGS. 6(A) and 6(B), respectively, for a 1.67 μm radius Silica fiber coupled to a 2.07 μm high by 1.507 μm wide SU-8-3000 waveguide.

Referring to FIG. 7, a plot of effective mode index against wavelength for the silica fiber and SU-8-3000 waveguide interface is shown. Arrows are located where the anti-crossing occurs. The top line 751 refers to the anti-symmetric mode, while the bottom line 752 refers to the symmetric mode.

Referring to FIG. 8, a plot of the effective mode profile of the small end of an inverse-tapered silicon waveguide of size 50 nm wide by 220 nm high surrounded by an SU-8-3000 waveguide of size 1.507 μm wide and 2.07 μm high is shown. Such a configuration can maintain 98% of the original intensity, i.e., 0.98 efficiency.

Referring to FIG. 9, a plot of the effective mode profile of the wide end of an inverse-tapered silicon waveguide of size 500 nm wide by 220 nm high surrounded by an SU-8-3000 waveguide of size 1.507 μm wide and 2.07 μm high is shown. Such a configuration can also to maintain 98% of the original intensity, in other words 0.98 efficiency.

1. A system for coupling electromagnetic radiation from an optical fiber into a waveguide, comprising:
at least one optical fiber for transmitting the electromagnetic radiation, and having a main portion and a distal portion, the distal portion being adapted for allowing at least a portion of a field generated by the electromagnetic radiation to exist outside of the at least one optical fiber; and
at least one waveguide having a surface adapted to receive the distal portion of the at least one optical fiber, the at least one waveguide being shaped such that the at least one optical fiber presses against the at least one waveguide creating a repeatable interface,
wherein the at least one optical fiber and the at least one waveguide are arranged such that at least part of the portion of the field existing outside of the at least one optical fiber extends into the at least one waveguide.

2. The system of claim 1, further comprising a photonic integrated chip having a surface, wherein the at least one waveguide is attached to the surface of the photonic integrated chip.

3. The system of claim 2, wherein the at least one optical fiber is positioned substantially parallel to the surface of the photonic integrated chip.

4. The system of claim 2, wherein the surface of the at least one waveguide is positioned substantially orthogonal to the surface of the photonic integrated chip.

5. The system of claim 1, wherein the at least one optical fiber comprises an optical fiber having a main portion with a diameter large enough so that no part of the field exists outside of the main portion of the at least one optical fiber.

6. The system of claim 1, wherein the at least one optical fiber comprises an optical fiber having a distal portion with a tapered region and a narrow region, the tapered region disposed between the narrow region and the main portion.

7. The system of claim 6, wherein the tapered region comprises a region between 10-1000 μm long, and the narrow region has a diameter between 0.1-10 μm.

8. The system of claim 1, wherein the at least one waveguide comprises a curved waveguide.

9. The system of claim 1, wherein the at least one waveguide further includes a straight portion, and wherein the at least one optical fiber and the at least one waveguide are arranged so that the repeatable interface is created along the straight portion of the waveguide.

10. The system of claim 1, wherein the at least one waveguide comprises one of a large polymer waveguide, a high index waveguide, and an inorganic waveguide.

11. The system of claim 1, further comprising a smaller waveguide connected to an end of the at least one waveguide, the smaller waveguide having a tapered end contained inside of the at least one waveguide.

12. The system of claim 11, wherein the at least one waveguide is a polymer waveguide and the smaller waveguide is a silicon waveguide.

13. The system of claim 1, wherein the at least one waveguide comprises a waveguide having an overhang projecting from the surface of the waveguide.

14. The system of claim 2, further comprising:
a plurality of thin spacers arranged along the surface of the photonic integrated chip adjacent to the surface of the at least one waveguide,
wherein the at least one optical fiber rests on the plurality of thin spacers such that the at least one optical fiber does not contact the surface of the photonic integrated chip.

15. A method for coupling electromagnetic radiation from at least one optical fiber to a photonic integrated chip, the photonic integrated chip having a surface and at least one waveguide attached to the surface of the photonic integrated chip, the at least one optical fiber having a distal portion adapted for allowing at least a portion of a field generated by the electromagnetic radiation to exist outside of the fiber, the at least one waveguide having a surface that is adapted for receiving the distal portion of the at least one fiber, the at least one waveguide being shaped such that the at least one optical fiber would create a repeatable interface when pressed against the at least one waveguide, the method comprising:
positioning the at least one optical fiber above the surface of the photonic integrated chip to approximately align the at least one optical fiber with the at least one waveguide;
translating the at least one optical fiber downwards to bring the at least one optical fiber into contact with the surface of the photonic integrated chip; and
translating the at least one optical fiber in a direction of the at least one waveguide along the surface of the photonic integrated chip to bring the at least one optical fiber into contact with the surface of the at least one waveguide.

16. The method of claim 15, further comprising translating the at least one optical fiber upwards relative to the surface of the photonic integrated chip, whereby the at least one optical fiber does not contact the surface of the photonic integrated chip.

17. A method for coupling electromagnetic radiation from a plurality of optical fibers to a photonic integrated chip, the photonic integrated chip having a surface, the surface of the photonic integrated chip having attached thereto a plurality of waveguides corresponding to the plurality of optical fibers, the plurality of optical fibers each having a distal portion adapted for allowing at least a portion of a field generated by the electromagnetic radiation to exist outside of each optical fiber, the plurality of waveguides each having a surface that is adapted for receiving the distal portion of one of the plurality of optical fibers, the plurality of waveguides being shaped such that each optical fiber would create a repeatable interface when pressed against the corresponding waveguide, the method comprising:
positioning the plurality of optical fibers above the surface of the photonic integrated chip so that each of the optical fibers is approximately aligned with the corresponding waveguide;
translating the plurality of optical fibers downwards to bring the fibers into contact with the surface of the photonic integrated chip; and
translating the plurality of optical fibers in a direction of the corresponding plurality of waveguides along the surface of the photonic integrated chip to bring the plurality of fibers into contact with the surfaces of the corresponding waveguides.

18. The method of claim 17, further comprising equidistantly spacing each of the optical fibers.

19. The method of claim 18, further comprising equidistantly spacing each of the plurality of waveguides to correspond to the plurality of optical fibers.

20. The method of claim 17, further comprising translating the plurality of optical fibers upwards relative to the surface of the photonic integrated chip, such that each of the plurality of optical fibers avoid contacting the surface of the photonic integrated chip.
